(19) United States
(12) Patent Application Publication
(10) Pub. No.: US 2019/0294764 A1
(43) Pub. Date: Sep. 26, 2019

(54) METHOD FOR REMOTELY AUTHORIZING LOGIN TO A COMPUTER SYSTEM

(71) Applicant: Elitegroup Computer Systems Co.,Ltd., Taipei City (TW)

(72) Inventors: Chin-Lee Teng, Taipei City (TW); Bo-Han Li, Taipei City (TW)

(21) Appl. No.: 16/198,684

(22) Filed: Nov. 21, 2018

(30) Foreign Application Priority Data
Mar. 21, 2018 (TW) 107109555

(51) Int. Cl. G06F 21/30; G06F 21/34; H04L 29/06

(52) U.S. Cl. CPC G06F 21/305; G06F 21/34; H04L 63/0428; G06F 2221/2137; H04L 63/0884

(57) ABSTRACT

A method for remote authorization to log into a computer system includes inserting a universal serial bus (USB) device to a USB port of the computer system to trigger a microcontroller of the USB device to execute a verification program, the verification program reading the information in the computer system through the USB port, the verification program, according the information, generating an authorization request, and sending the authorization request through a network interface of the USB device to an authorizer's device, the authorizer's device generating and sending an authorization response to the USB device in response to the authorization request, and the verification program, according to the authorization response, making the USB device to simulate an input device for inputting an account and a password of a user to the computer system so as to log in to the computer system.

### BACKGROUND OF THE INVENTION

### 1. Field of the Invention

The present invention is related to a method for remotely authorizing login to a computer system, especially to a method for remotely authorizing login to a computer system through a universal serial bus (USB) device.

### 2. Description of the Prior Art

When team member A needs the information in team member B's computer, team member A cannot log in to team member B's computer to get the information without team member B's login account and password because of information security.

Presently, Microsoft and TeamViewer each provide a remote authorization method. The Microsoft Windows system provides the Remote Desktop function. It is based on the remote desktop protocol (RDP). Yet, the Remote Desktop by Microsoft can only operate in Windows operating system. It therefore lacks cross platform function. On the other hand, when a user uses TeamViewer for remote desktop connection, TeamViewer has a dedicated server to manage and confirm the connected user. When computers on different sites connect to the server of TeamViewer, the server distributes an account to the computer. The user only needs to input the server account and the password to establish connection, even cross platform. However, because certain network domains (e.g. corporate regional network) would block data transfer from the server of TeamViewer, some users cannot use TeamViewer for remote connection.

### SUMMARY OF THE INVENTION

An embodiment discloses a method for remote authorization to log into a computer system comprises inserting a universal serial bus (USB) device to a USB port of the computer system to trigger a microcontroller of the USB device to execute a verification program, the verification program reading the information in the computer system through the USB port, the verification program, according the information, generating an authorization request, and sending the authorization request through a network interface of the USB device to an authorizer's device, the authorizer's device generating and sending an authorization response to the USB device in response to the authorization request, and the verification program, according to the authorization response, making the USB device to simulate an input device for inputting an account and a password of a user to the computer system so as to log in to the computer system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a hardware block diagram of a method of remote authorization according to the present invention.

FIG. 2 is a flow chart for an embodiment of a method to remotely authorize login to the computer system in FIG. 1.

### DETAILED DESCRIPTION

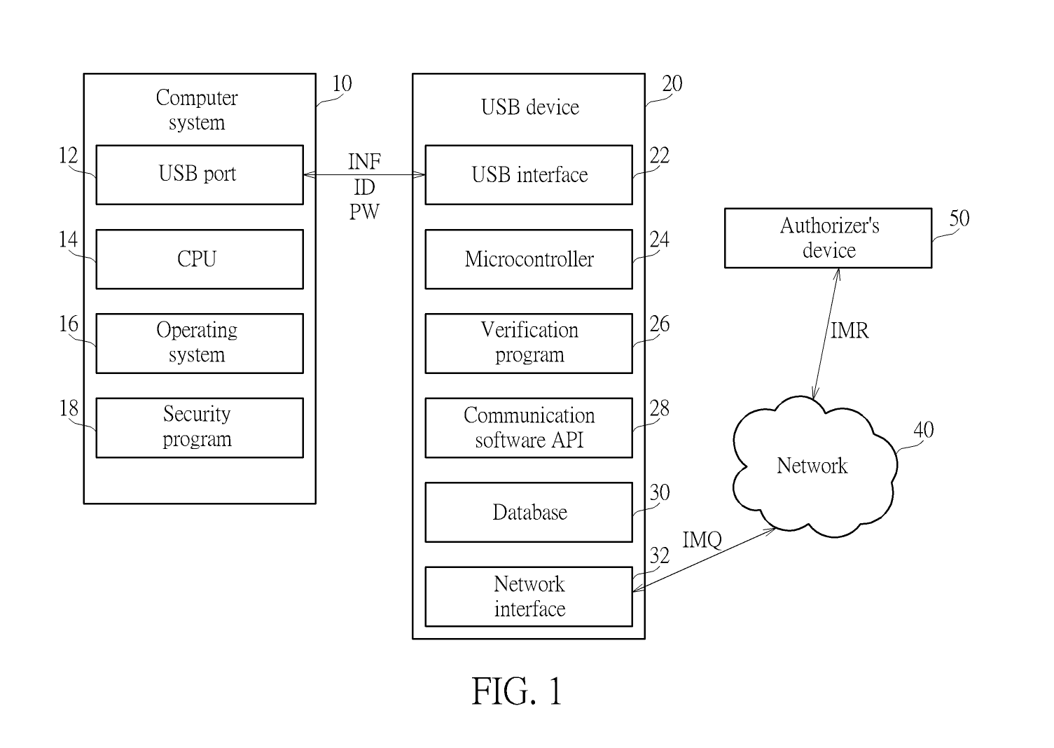

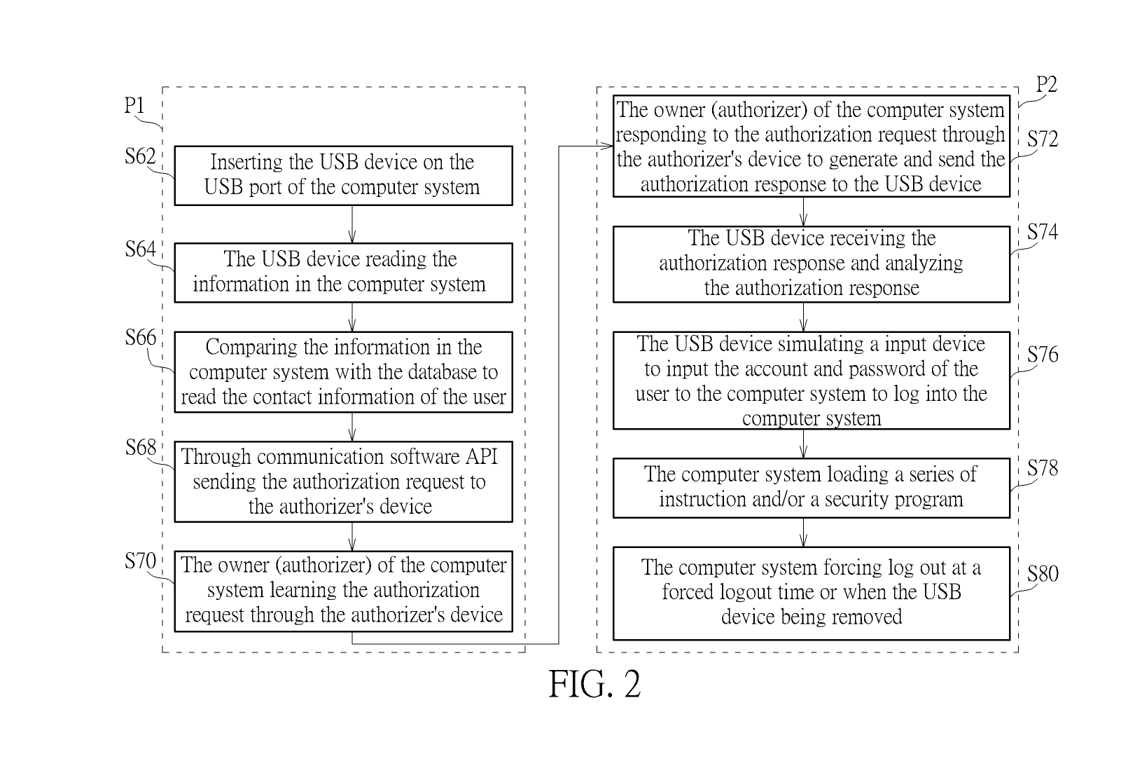

FIG. 1 is a hardware block diagram of a method of remote authorization according to the present invention. FIG. 2 is a flow chart for an embodiment of a method to remotely authorize login to the computer system in FIG. 1. In this embodiment, the hardware structure may comprise a computer system 10 to be logged in, a universal serial bus (USB) device 20, network 40 and an authorizer's device 50. The computer system. 10 comprises a central processing unit (CPU) 14 and an operating system 16. When a user wants to log into the computer system 10, he only needs to insert the USB device 20 to the USB port 12 of the computer system 10. The USB device 20 would then inform the authorizer to complete authorization process and log into the computer system 10 after the authorization is granted. The USB device 20 can be built on embedded systems such as Arduino, Raspberry Pi . . . etc. Further, the network 40 can be a cellphone network, the Internet . . . etc. The authorizer's device 50 is a device used by the authorizer. It can be but not limited to a cellphone, a tablet and other electronic devices.

This embodiment may include two processes. One process is a request process P1 and the other process is a remote authorization login process P2. The request process P1 includes step S62 to step S70. In step S62, an operator inserts the USB device 20 in the USB port 12 of the computer system 10. When the USB device 20 is inserted in the USB port 12, the USB interface 22 of the USB device 20 would be coupled to the USB port 12 of the computer system 10. The USB device 20 would be powered by the USB port 12. Then, the microcontroller 24 of the USB device 20 can detect the insertion activity of the USB device 20 to trigger a verification program 26. After that in step S64, the verification program 26 reads the information INF in the computer system 10. The above mentioned information INF in the computer system 10 is mainly provided for the USB device 20 to determine who the user (authorizer) of the computer system 10 is. Therefore, the information INF of the computer system 10 can include but not limited to the login system file, the IP address, the MAC address . . . etc. In step S66, the verification program 26 would compare and search the information INF in the computer system 10 and the data in database 30 to read the contact information of the user for the computer system 10. The database 30 can store the contact information for users of multiple computer systems to apply the USB device 20 at different times on the computer systems. Further, the previously described contact information of the user in the computer system 10 can be but not limited to an email address, a Skype account, a cellphone number . . . etc. In step S68, the verification program 26 generates an authorization request IMQ according to the contact information of the user, and sends the authorization request IMQ by the network interface 32 of the USB device 20 through the network 40 to the authorizer's device 50. The authorization request IMQ can be an email, a Skype message or a cellphone text message, according to the type of contact information mentioned above. Using the example of a Skype account as the contact information, the verification program 26 can by communication software API 28 generate and send an authorization request to the corresponding Skype account. In another example, if the contact information is an email address, the verification program 26 would send the authorization request IMQ to the corresponding email address. If the contact information is a cellphone number, the verification program 26 would then send the authorization request IMQ to the corresponding cellphone. Further, in another embodiment of this invention, the authorization request is encrypted by the verification program 26. It can prevent the authorization request IMQ from being tampered during the transmission. After the authorizer's device 50 receives the authorization request IMQ, the owner (authorizer) of the computer system 10 will be able to learn the authorization request IMQ through the authorizer's device 50 (step S70).

The remote authorization login process P2 comprises step S72 to step S80. In step S72, by the authorizer operating on the authorizer's device 50 to respond to the authorization request IMQ, the authorizer's device 50 generates an authorization response IMR and sends the authorization response IMR to the USB device 20 through the network 40. In an embodiment of this invention, after the authorizer accepts the user to log into the computer system 10, the authorizer's device 50 can add the password PW and/or the account ID to the authorization response IMR with an encryption process. In step S74, the USB device 20 receives the authorization response IMR and begins to analyze the authorization response IMR. If the authorizer's device 50 in step 72 adds the password PW and/or the account ID into the authorization response IMR, the USB device 20 in step S74 can decode the authorization response IMR to get the password PW and/or the account ID. In an embodiment of this invention, the account ID and the password PW are stored in the database 30. After the USB device 20 receives the authorization response IMR and confirms the authorizer accepting the authorization, the verification program 26 will get the account ID and the password PW of the authorizer from the database 30. In another embodiment of this invention, the account ID can be included in the information INF in the computer system 10 and the password PW is stored in the database 30. After the USB device 20 receives the authorization response IMR and confirms the authorizer accepting the authorization, the verification program 26 will get the password PW from the database 30. In yet another embodiment of this invention, the authorization response IMR includes a specific instruction, the verification program 26 can convert the instruction to the password PW of the user. Further, in step 76, according the response IMR, the verification program 26 would make the USB device 20 simulate an input device, such as a keyboard, to input the account ID and password PW of the user to the computer system 10 to login. Step S78 and S80 can be optional. In step S78, the computer system 10 would load a series of instructions and/or a security program 18 to set a forced logout time to let the user log out the computer system 10 at the above mentioned time (step S80). In another embodiment of this invention, the computer system 10 performs step S80 when the USB device 20 is removed from the USB port 12. The loaded instruction and/or the security program 18 would force the account of the user to log out the computer system 10.

In summary, by the method of remote authorization login to the computer system described through the embodiments of this invention, when the user inserts the USB device in the USB port of the login computer, the USB device can read the information in the computer system and sends an authorization request to the authorizer's device according to the information. If the authorizer accepts the request, an authorization response would be sent back. The USB device would then log into the computer system according the authorization request. Because the authorizer does not need to let the user know the login password, the account of the authorizer can be secured. Further, the authorization request and the authorization response can be transmitted through communication software such as Skype to achieve cross platform purpose. Finally, the application of this invention is a convenient method to solve the problem which the user needs to log into the computer without the authorizer's physical presence.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for remote authorization to log into a computer system comprising:
inserting a universal serial bus (USB) device to a USB port of the computer system to trigger a microcontroller of the USB device to execute a verification program;
the verification program reading information in the computer system through the USB port;
the verification program generating an authorization request according the information in the computer system, and sending the authorization request through a network interface of the USB device to an authorizer's device;
in response to the authorization request, the authorizer's device generating and sending an authorization response to the USB device; and
according to the authorization response, the verification program making the USB device to simulate an input device for inputting an account and a password of a user to the computer system so as to log in to the computer system.

2. The method of claim 1, wherein the USB device comprises a database, and the method further comprises:
the verification program finding contact information of the user from the database according to the information in the computer system; and
the verification program sending the authorization request to the authorizer's device according to the contact information.

3. The method of claim 1, further comprising:
after the user successfully logs into the computer system, the verification program loading a series of instructions to set a forced logout time for forcing the computer system to log out the account of the user at the forced logout time.

4. The method of claim 1, further comprising:
after the user successfully logs into the computer system, the verification program loading a series of instructions for forcing the computer system to log out the account of the user when the computer system detects the USB device is removed from the USB port.

5. The method of claim 1, wherein the authorization response includes the password of the user.

6. The method of claim 1, wherein the authorization response includes a specific instruction, and the verification program converts the specific instruction to the password of the user.

7. The method of claim 1, wherein the information in the computer system includes the account of the user.

8. The method of claim 1, wherein the authorization request is encrypted by the verification program.

9. The method of claim 1, wherein the authorization response is encrypted by the authorizer's device.
